(19) United States
(12) Patent Application Publication
(10) Pub. No.: US 2015/0135160 A1
(43) Pub. Date: May 14, 2015

(54) SYSTEM AND METHOD FOR PROVIDING AN APPLICATION DEVELOPMENT AND DISTRIBUTION SOCIAL PLATFORM

(71) Applicants: Simon Gauvin, Moncton (CA); Omid Banyasad, Moncton (CA)

(72) Inventors: Simon Gauvin, Moncton (CA); Omid Banyasad, Moncton (CA)

(21) Appl. No.: 14/398,343

(22) PCT Filed: May 1, 2013
(86) PCT No.: PCT/CA2013/000435

§ 371 Date: Oct. 31, 2014

Related U.S. Application Data
(60) Provisional application No. 61/640,939, filed on May 1, 2012.

(51) Int. Cl. G06F 9/44; H04L 12/58

(52) U.S. Cl. CPC G06F 8/30; H04L 51/32; G06F 8/34; G06F 8/20
USPC 717/109; 717/100; 717/106

(57) ABSTRACT

A computer network implemented application development platform is provided that includes or links to a social networking environment and that includes an application development utility. The application development utility enables one or more development users to develop, publish and/or distribute one or more applications using one or more resources of the application development utility and the social networking environment; and one or more application users to discover and access one or more applications using the social networking environment and the server application. The application development platform implements a novel method for building, publishing, and distributing applications using the social networking environment.

### PRIORITY CLAIM

This application claims all benefit, including priority, of U.S. Provisional Patent Application Ser. No. 61/640,939 filed May 1, 2012.

### FIELD OF INVENTION

The present invention relates to social networks. The present invention also relates to application development technology platforms and methods.

### BACKGROUND OF THE INVENTION

Software application development (such as for example web application development or mobile application development) generally follows a well established workflow. Application developers may work for example for a business entity as part of an in-house application development team. Or a business entity may hire an outside developer, either as a contractor or as part of a development firm. Application development generally includes a requirements discovery phase; a functional specification development phase; a technical specification development phase; a development phase; a testing/correction phase; and release.

Application development is generally quite fragmented. Numerous applications may share functions or features with numerous other applications, yet functions and features are often duplicated in parallel development projects. While developers increasingly incorporate or link to available tools to reduce duplication, and hence time and costs involved in development, duplication continues to be a problem.

In addition, the requirements phase mentioned above may involve or rely on market analysis to assess the need for or demand for the application in question. This market information can be costly to compile and may not be reliable.

Furthermore, distribution of applications can be costly in part because of intense competition in numerous domains to attract user interest, and once a User has subscribed to a particular application it can be difficult to assure their continued use of the application.

Developers who work separately may have compatible skills, experience, or code sets, but if they are working separately then there is lithe opportunity for them to find each other and to collaborate to improve application functionality, development costs, and time to market for their respective customers.

A number of prior art development platforms exist that seek to alleviate some of these problems. For example APPMOBI™ provides a mobile application development ecosystem that provides tools for designing and building mobile application. Other similar examples include: RHO MOBILE™, SENCHA™, TIGGR™. MAGMITO™ and APP.CAT™. These platforms are based on providing tools to developers and in some cases allowing developers to develop and share with other developers their tools or content.

Despite the existence of application development platforms, application development remains a relatively technical process. While consumers may be interested in leveraging for example a special interest or expertise into an application that they can distribute, meeting market demand and generating revenue, application development continues to remain beyond the reach of such average consumers. Application development tends to remain the domain of application developers and application development firms. Consumers or businesses that may have an idea for an application that may be of interest to a particular demographic must generally hire an application developer. But given the relatively significant costs involved, and the difficulties in predicting demand, return on investment may be less desirable for development projects. This creates barriers to entry for development and distribution of applications that may otherwise be of interest to users and that may benefit them.

A further challenge in commercializing applications is that updating and maintenance of applications using existing platforms and processes can also be time consuming and costly.

Commercialization of applications is increasingly dependent on advertising revenue. This creates demand for incorporating analytics functionality, which may in turn be used to optimize application features and distribution methods to increase advertising revenue. These features can be expensive based on prior art platforms and methods, and as stated earlier updating of application features and functions to improve advertising revenue performance can also be expensive.

It should also be noted that based on prior art platforms and methods, distribution of applications can be costly, especially if there is a desire to generate adoption traction in a timely manner.

The factors mentioned above create barriers to the development and distribution of useful applications.

There is a need for an application development platform that addresses the described disadvantages.

The example of mobile applications further explains the need for the application development platform and method provided by the present invention.

Four billion mobile phones are now in use world-wide with one billion of these being smartphones. This large base of smartphones accounts globally for a 6 billion-dollar application sales market, a 1.6 billion dollar mobile ad market, and a 1 billion-dollar enterprise services market. According to industry trade publications Vision Mobile, Gartner, and Forrester Research, these markets are expected to double every year for the next three years based on the continued sales of smartphones at a CAGR of 34.2% through to 2015. The dynamics of the mobile enterprise services market is influenced by both the mobile smartphone and mobile application industries.

Apple's application store now hosts over 500,000 applications which have been downloaded over 25 billion times. Big business has taken notice with 350 of the Fortune 1000 companies sporting branded applications. Forrester Research recently published results of a survey of 400 companies showing that 80% are considering development of applications for their employees in the next 24 months. However, few programmers know how to develop applications, project costs are high, development times long, and application stores continue to be a bottleneck for application discovery and a pinch point taking 30% of developer revenues.

Mobile application development is one of the fastest growing segments in the information technology and communication sector today. Yet, of the one billion smart phone users, less than 0.05% are capable of making applications. There is tremendous demand for mobile applications that current development human resources are simply not able to meet.

Developing mobile applications is further complicated with the challenges of the mobile device market being fragmented. There is a plurality of different platforms and even within a single platform different versions of mobile applications may be required to address mobile device to mobile device differences. Hardware platforms are incompatible, as are programming languages, ad frameworks, and software development tools. As a result, creating cross platform mobile applications can be costly, time consuming and technically challenging. This adversely affects ad revenues which often do not reach an acceptable return on investment. Because of the fragmentation of mobile operating systems in particular, each mobile application can only generate ad revenues from a portion of market (48% max on Android).

Furthermore, the current distribution mechanisms for discovering mobile applications of interest are generally ineffective. Applications stores such as the Apple “APPLSTORE” are the primary mechanisms for finding mobile applications of interest, navigating the APPSTORE can be time consuming, and so there is a tendency to download one of the more popular mobile applications, rather than to find a mobile application that perhaps is not yet popular, however it meets the particular requirements or interest of a user. Application stores therefore create bottlenecks to consumer application discovery for example to the point where some studies report that 74% of application publishers report lower than expected revenues.

Application developers are at the mercy of application store validation and certification processes that can result in long delays in publishing (45-120 days), or possibly rejection, delaying revenues.

Although application stores provide some basic analytics of application downloads and usage developers do not have direct contact with their customers to gain feedback or market new features.

Application development tools have yet to become usable enough to allow in-house web developers the opportunity to build sophisticated applications required of their enterprise. Technologies used by web-developers, such as Adobe Flash, are not supported by the majority of mobile platforms for application development, therefore this group has been pushed out of the mobile app market.

The factors mentioned above create barriers to developing and deploying mobile applications.

There is a need for a mobile application development platform and workflow that addresses the mentioned requirements.

### SUMMARY OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

In one aspect, a method of developing one or more applications using a computer network implemented development platform is provided, comprising the steps of:
(a) a user accessing an application development utility that is implemented to one or more servers connected to an interconnected network of computers and linked to at least one server application, wherein the server application enables a social networking environment, or links to a social networking environment;
(b) the user using the application development utility to select one or more application attributes for an application;
(c) the user selecting, from one or more digital objects displayed by the application development utility, application feature objects corresponding to the application attributes, wherein the application feature objects consist of or links to executable code stored to a database linked to the server application;
(d) the user selecting one or more user interface items for the application from one or more further digital objects displayed by the application development utility based on the application attributes and the application feature objects; and
(e) the application development utility dynamically building the application based on the application feature objects and the one or more user interface items so as to enable one or more application users to access the application using one or more network connected devices via the server application;
wherein the server application enables the user to develop, publish and distribute the application by means of the social networking environment.

In another aspect of the method, application users find the application and gain access to the application using the social networking environment,

In a still other aspect of the method, the user uses the application development utility to access a visual programming environment to arrange and configure the application feature objects and the one or more associated user interface items so as to enable the composition of a functional application.

In another aspect of the method, the application developer utility presents an application home page for the application that enables the development, publication and distribution of the application using the social networking environment,

In accordance with other aspects of the present invention there is provided a non-transitory computer program product tangibly embodying code that, when executed by a processor, causes the processor to carry out the method of the present invention.

In another aspect, a computer network connected computer system for developing computer programs is provided comprising: one or more server computers connected to an interconnected network of computers; a computer network implemented social networking service implemented by the one or more server computers, or connected to the one or more server computers; and a computer network implemented application development service implemented by the one or more server computers; wherein the social networking service and the application development service are integrated so that: one or more users registered to the computer system can access one or more features of the application development service for designing and assembling one or more functioning applications, and publish these applications via the social networking service; and one or more other users registered to the computer system can discover applications, select one or more applications, and access the applications through the computer system, using a network connected computer device or a mobile device.

In another aspect, the application development service when accessed presents to the user one or more development screens configured to enable the one or more users to: select one or more application attributes for an application; select from one or more digital objects displayed by the application development service that correspond to application functional attributes, wherein the application feature objects consist of or link to executable code stored to a database linked to the computer system; and select one or more user interface items for the application from one or more further digital objects displayed by the development screens based on the selected application attributes and the application feature objects; wherein the application development service dynamically builds the application based on the application attributes, application feature objects, and the one or more user interface items, so as to enable one or more application users to access the functions and features of the application by connecting to the computer system using their network connected computer device or mobile device.

In a still other aspect, the application development service includes one or more computer program components including computer program instructions based on a visual programming language, such that the application development service enables the one or more users to select, arrange, and configure the application feature objects, which are executed by the computer system so as to present a functional application composed by the one or more users.

In another aspect of the computer system, the social networking service provides to registered users an application home page for one or more applications associated with one or more registered users, wherein the application home page presents public information defined by the registered users, and back end management features to the registered users for developing, maintaining, promoting, and distributing the application.

In yet another aspect, the social networking service, or a social networking platform linked to the social networking service, enables users of the computer system to build and manage their social network, and the computer system enables the users who are registered to the computer system as controlling the application to: distribute applications using their social network; solicit feedback regarding applications, or development versions of applications, from their social network; and collaborate with members of their social network to develop and distribute applications.

In a still other aspect, the application development service streamlines and simplifies the development of applications so as to enable subject matter experts to develop and distribute applications based on their subject matter expertise, and using their social network.

In another aspect, registered users of the computer system may be developers of applications and users of applications.

In another aspect, the computer system includes or links to an e-commerce utility that enables users who are developers to monetize their applications, or components of applications such as objects, scripts, templates, widgets, APIs, media, and other items.

In yet another aspect, the computer system automatically tracks applications linked to the system, and its components, and enables users controlling such applications or application components to set one or more rules for sharing such applications or application components with other users who may require access to application or application components, and based on such rules publishes applications or application components to one or more shared libraries, thereby reducing duplication across different application development projects that share common attributes.

In a still other aspect, the computer system provides one or more tools that enable a developer user to use the social network to promote their application, including: an application store that allows user of the computer system to search for and access information regarding applications that map to their interests; and a targeting tool that permits developer users to target users who may be interested in an application including based on segmented targeting of users based on the computer system developing insights regarding the subject matter interests of users.

In another aspect, the computer system, information regarding applications that may be of interest to a user is distributed using social media feeds through the social media service or the social media networking platform linked to the computer system.

In an aspect of the computer system, the computer system uses logs and analyzes automatically social media feeds associated with users to discover interests of users in applications and generate data for promoting applications to groups of users.

In a still other aspect, the computer system presents to developer users a dashboard that includes information and tools that assist the developer users in promoting their application, including via the social network or the social networking platform linked to the computer system.

In yet another aspect, the application development utility includes or links to a visual programming language and environment to arrange and configure the application feature objects and the one or more associated user interface items so as to enable the composition of a functional application.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1a is system diagram of the system of the present invention;

FIG. 1b is a further system diagram illustrating features of a social networking platform for enabling the social media interactions of the present invention:

FIG. 2 is a diagram illustrating at a high level the resources integrated in the system of the present invention, in one implementation thereof;

FIG. 3a is a further system view of the present invention, in one particular implementation thereof;

FIG. 3b is a further system view of the present invention, showing a particular implementation of a SaaS based implementation of the present invention;

FIG. 3c is further system view of the present invention, showing an example of the implementation of the present invention as a server stack;

FIG. 4 is a diagram illustrating the web page types enabled by the social networking environment (104), in one implementation thereof;

FIGS. 5-8 illustrate representative screen arrangements for the web pages enabled by the social networking environment (104), in one implementation thereof;

FIG. 9 illustrates a representative screen presented by the development system (112) of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention consists of an innovative application development platform (100) (“platform”). In one aspect of the invention the platform (100) includes a series of utilities designed to enable a plurality of users to design and distribute applications (102), all through the platform (100). Significantly, and in contrast with prior application development platforms, the development and distribution platform (100) implements a social network environment (104), that enables users to develop applications (102), including on a collaborative basis. The social networking environment (104) is supported and managed by operation of the platform (100), and more particularly a social networking platform (106) that may be made part of the platform (100), or may be linked to the platform (100) of the present invention.

It should be understood that the social networking platform (106) may consist of a third party social networking platform, configured to provide the functions and features described herein, and in particular to support the application development and distribution workflows described herein. For example, the social networking platform (106) may be implemented using one or more applications deployed on the third party social networking platform, such as FACEBOOK™ applications. In addition, the social networking platform (106) may be deployed as a standalone social media networking infrastructure (implemented in a manner that is known) that integrates with one or more aspect of one or more third party social networking platforms such as FACEBOOK. For example, in connection with FACEBOOK, the “Open Graph” API (“Application Programming Interface”) may be utilized by the present invention. As the skilled reader will understand, the Open Graph API enables extension of the social graph to third party web sites and web pages. Open Graph is used to enable people to “like” a third party website and to reflect this within FACEBOOK. Also, it is the Open Graph API that permits a user to log into FACEBOOK through a third party website relying on FACEBOOK CONNECT™ that enables linking to the FACEBOOK API from a third party website. The Open Graph API has also been extended to third party applications or platform enabling for example an action within a third party application to result in the publication of actions within FACEBOOK, i.e. news feeds, tickers, and timelines. It should be understood therefore that by leveraging this functionality, various social media interactions described in this disclosure may leverage social graphs established through FACEBOOK (for example) and also events in social networking platform (106) of the present invention, for example the publication of a new mobile application, may be published through social networks established using a third party social networking platform such as FACEBOOK. The inventors have conceived of and designed the social networking platform of the present invention in a way that is designed to make the development and consumption of applications, including mobile applications, “social”. This very idea, and the advantages it will accrue to developers of applications and consumers of applications, is highly innovative. Moreover, the present disclosure explains a number of different aspects of the social networking platform of the present invention, which constitute additional features and aspects that each individually constitute important innovations in extending the concept of making the development and consumption of applications, including mobile applications, social and thereby create a dynamic ecosystem in which applications, including mobile applications, that engage consumers can be developed and distributed efficiently. It is further noted that the integration of the social networking platform with third party platforms such as FACEBOOK, as described, also represents important innovation, as a skilled reader will understand.

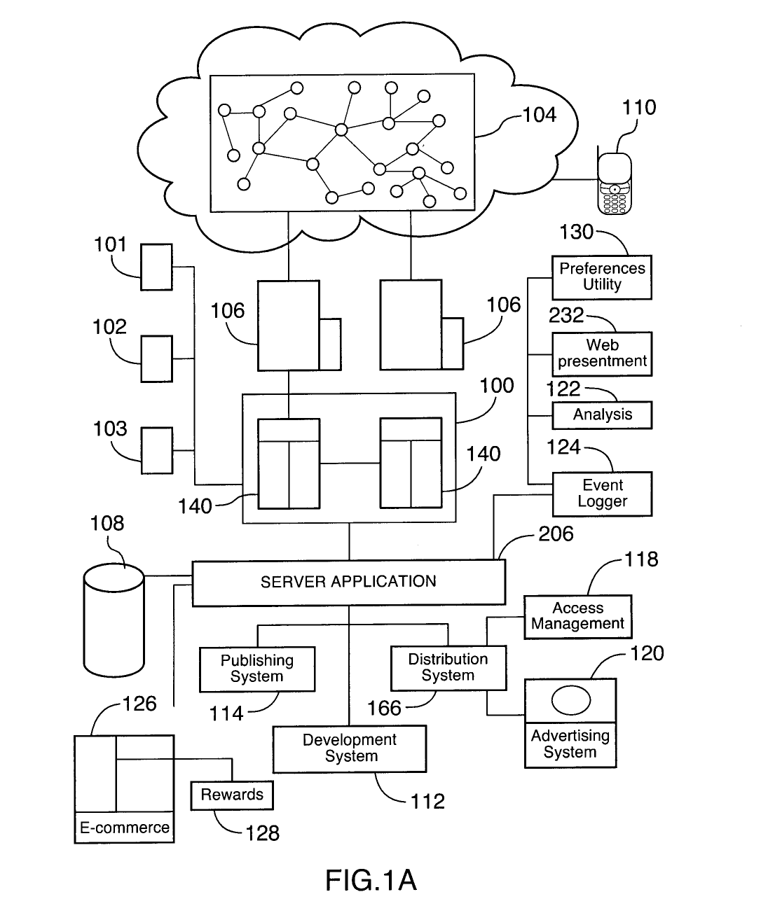

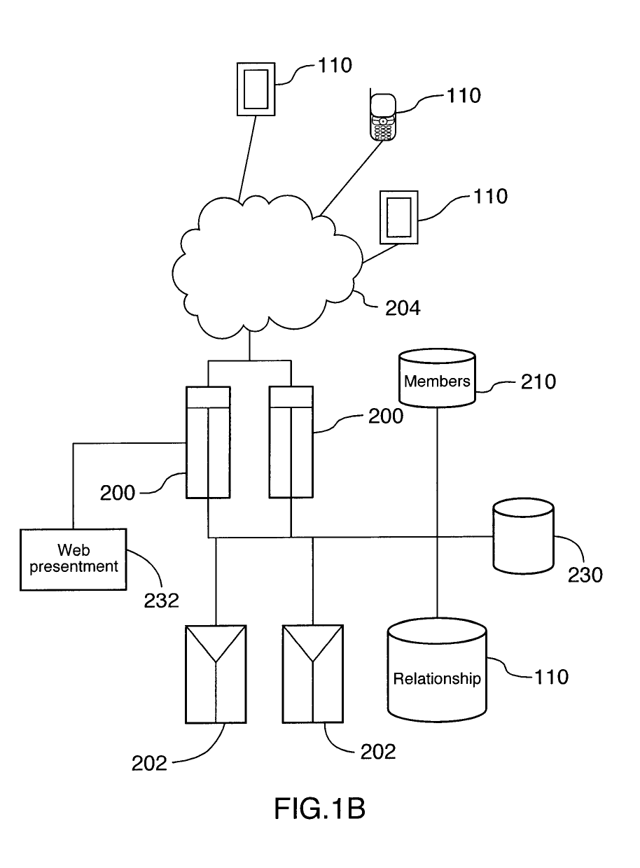

The social networking platform (106) is generally implemented using one or more application servers, as illustrated in FIG. 1b. FIG. 1b is a block diagram illustrating a system for creating and managing an online social network, including for the purposes of development and distribution of applications in accordance with the present invention. FIG. 1b illustrates a system 140, including an application server 200 and graph servers 202. The computers of system 140 are connected by a network 204, e.g., the Internet, and accessible over the network by a plurality of computers 110. The application server 200 manages a member database 210, a relationship database, and a search database 230.

The application server 200 may include a web presentment utility 232. The web presentment utility 232 may be a standard utility or set of utilities operable to present one or more web pages based on the workflow or social interactions described herein.

References herein to devices, for example, such as mobile or portable devices, that may be mobile or portable communication devices, may include many types of devices such as any of the following: cell phones, smart phones, PDAs, digital music players, GPS devices, e-book readers, portable gaming devices, digital cameras, tablets, netbooks, laptops, and any other devices that may be mobile or portable.

Prior art solutions did not conceive of the possibility of creating a social networking environment for application development using social networks, Prior art solutions also did not conceive of the benefits of integrating in such a social networking environment not only application development but also distribution of applications using social networks built by for example application developers via the social networking environment. The development and distribution platform (100) of the present invention integrates in a seamless and user friendly way a plurality of platform features that enable the leveraging of social interaction in support of application development and promotion in novel and innovative ways. A number of the significant advantages conferred by the innovative platform (100) of the present invention are set out in the description below, and also in the advantages section.

Web Platform

In one aspect of the invention, the platform (100) as shown in FIG. 1a includes a server application (206) for providing the social networking environment 104, and more particularly a social networking environment that is part of broader Internet platform, for enabling the development, distribution, and discovery of web applications, including mobile web applications.

The server application, also as shown in FIG. 1a includes a database (108).

It should be understood that while this disclosure refers to web applications, the present invention applies to any network enabled computer program. The platform enables the development, distribution and discovery of web applications that may consist of web applications programmed in HTML5 or JavaScript, and that may be provisioned to a mobile device (110) by using a mobile web browser (not shown) used to access web server (140). While the present disclosure refers principally to web applications, including mobile web applications, the system, method and computer program of the present invention also extends to the development, distribution, and discovery of native mobile applications for example, i.e. mobile applications (102) consisting of compiled binary files uploaded and installed through the operating system associated with the particular mobile device (110) (whether IOS™, ANDROID™, BLACKBERRY™ or otherwise.

Data Architecture

As shown in FIG. 1a, the web server (140) is linked to a database (108). In one particular aspect of the invention, all data associated with applications (102) is stored on the server side. The database (108) may be implemented for example as a hierarchical database, in which each user may be assigned a data store on the database (108), and this data store functions for that user as a central data store, linked to the various applications (102) that the user is authorized to access by operation of the system. The database (108) is linked to the access management utility (118) for restricting access to the database (108), and also to individual data stores, to authorized users only.

The database (108) may include a plurality of resources such as various tools in a number of different possible media for supporting the development and distribution of applications (102). The tools may include for example video tutorials, presentation slides, or digital brochures.

System Attributes

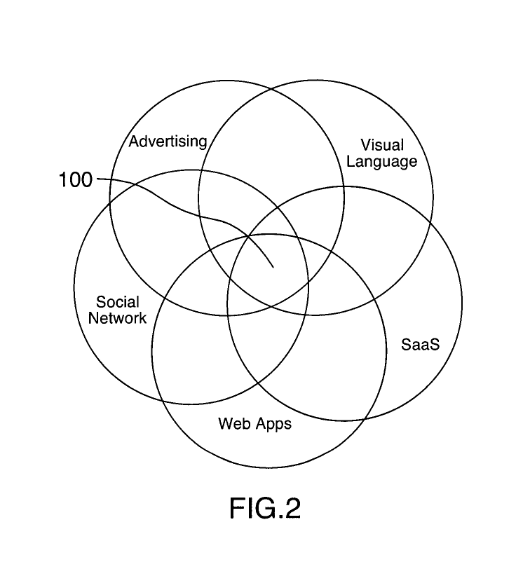

As shown in FIG. 2, the platform (100) in one implementation is characterized by integration into a single web platform of the following resources: (A) a development platform based on visual programming (see details below), (B) a Software as a Service (“SaaS”) model for delivery of development utilities through the development platform, (C) a social network for social interactions between users of the web platform, including in connection with development, distribution and discovery of applications, (D) an advertising infrastructure to support the revenue models associated with the platform, (E) mobile web applications developed and provisioned to the users of the platform, although the present invention extends to other types of applications including web applications more generally, and also not native mobile applications,

Other aspects of the platform (100) include:
1. In accordance with the SaaS model of the platform (100), all of the platform features may be provided as a service contained within a browser application. It is noted that prior art development platforms did not conceive of the possibility of providing a development platform based on a SaaS model and integrating the other resources mentioned. It is noted that in addition to the accessibility of the platform functions to users based on the SaaS model, another advantage to the users is that based on the SaaS model, the operator of the platform (100) can continuously extend the platform features, and streamline and improve the usability of development workflows for example, in a seamless manner and that does not disrupt the various activities of the different types of users on the platform (100). It will be understood by reviewing aspect of the description below, that another advantage of providing an integration platform (100) of the present invention, is that the deep insights may be obtained regarding development processes and trends, and demand for and engagement with particular application functionality by operation of the analytics engine (122) described below. These insights may be used to develop new functionality which can be easily deployed based on the SaaS model of the platform (100).
2. In accordance with the platform (100) of the present invention development, distribution, and discovery of applications is based on activities facilitated by the platform (100) as part of a social network of users (developers, consumers of applications, and optionally enterprises as explained below) and also applications. Prior to the present invention, no social network of such users and applications was provided or suggested. Platform users can connect to each other or to applications, and build personal networks based on interest in developing applications (including collaboratively by means of the social networking environment), discovering applications (for example applications with particular themes or functionality), or distribution of applications (including by developers who are part of the social networking environment cross-recommending each other's applications). This provides significant advantages to the various users as further explained below.
3. The platform (100) integrates a robust advertising platform, including mobile advertising platform, that enables the generation of revenue for developers and also by enterprises using the platform (100) to have made applications (102).

It merits highlighting that the platform (100) does not differentiate between users who are developers or consumers of applications (102). Developers of applications are consumers of other applications. Consumers may develop applications (102) over time, for example, based on what they have learned by using other applications or ideas for applications programming or content that they may have developed through social media interactions with other users, who may be consumers or developers. The absence of discrimination between developers of applications and consumer of applications breaks down barriers between these two groups who both play important roles in developing a vibrant market for applications. By so doing, the market for applications (and especially mobile applications) improves.

Further referring to FIG. 1a, the server application (206) may include or be linked to a plurality of components as described below.

Referring now to FIG. 1a, in a particular aspect of the invention, the platform (100) includes a development system (112) (which is further detailed below, in one embodiment thereof), which may include one or more application development tools, which may be based on the use of a visual data flow programming language, that simplifies application development.

In one aspect of the invention a framework is provided for visual programming language development as a Web 2.0 SaaS.

In another aspect of the invention, the platform (100) also integrates a publishing system (114), which is best understood as one or more utilities, that are operable to collect the program code, assets, libraries, and various components together to assemble an application (102) that may be distributed within the platform (100) that make an application and combines them to form a complete application to be distributed. In one particular aspect of the present invention, the publishing system (114) may be configured to automatically validate an application (102) by incorporating one or more operations for validating programming and content that is part of an application (102). In one aspect of the invention, the platform (using the publishing system (114) in one implementation) may be understood to enable “one click publishing” of applications (102) wherein a user who is a developer may launch an application (102) for distribution, including based on the novel and innovative distribution methods described in this disclosure. The waiting times, testing requirements, and possibly costs associated with gaining acceptance of an application by an application store are no longer necessary, yet by operation of the platform (100) of the present invention, effective operation of applications (102) is assured. Various users may connect to the system, including for example a user who is a consumer (101) and also a user who is a developer (103).

In another aspect of the invention, the platform (100) allows removal of all HTML code from the creation to delivery of applications, using a proprietary front-end builder code that directly manipulates the DOM on mobile devices and desktop computers.

In yet another aspect of the invention, the platform (100) may also integrate a distribution system (116), which may be implemented as one or more processes or utilities implemented by the social networking platform (104). The distribution system (116) provides one or more mechanisms for delivering applications (102) to consumers for the application (102). The server application (206) may include an access management utility (118) that enables authorized users to determine the rules for other users to access particular assets such as applications (102) linked to the platform (100). The access management utility (118) is linked with the distribution system (116) so as to establish permissions for consumers accessing particular applications (102). These permissions may include subscribing to an application (102), in one implementation. The distribution system (116) may also incorporate user authentication, verification, application delivery, data access, and definition of advertising parameters for implementation by the advertising system (120) in connection with distribution of the applications (102).

In one aspect, the distribution of applications (102) may occur inside or outside of the social network. For example, applications (102) may first be distributed inside the social network and then may be exploited as commercial products outside of the social network.

In another aspect of the invention, the advertising system (120) may be connected to one or more ad networks (including for example a mobile ad network) in order to enable the publication of advertisements within applications (102), in order to support the platform revenue model. The advertising system (120) is also operable to collect advertising interaction metrics (such as ad impressions and associated consumer information), which is provided to the ad networks for impression tracking, and also to the analytics engine (122). The advertising system (120) may include a range of different advertising related functions and features such as for example various targeted advertising techniques, which may be based for example on the location of the user of the application (102) at a particular time, capture of information in connection with the use of an application (102) that is indicative of consumer intent, for example capture of key words provided as input by a user that is indicative of their intent or interest, which may be used to target ads to the user that are likely to be of interest in order to improve click-through rates, and in turn to improve advertising revenue. Many other mechanisms for targeting of ads may be used.

The server application (206) also includes an event logger (124) that is operable to log all events in the platform (100) to a store of the database (108). This store is made accessible to the analytics engine (122). The analytics engine is operable to enable data analysis of application (102) use on a per application basis, multiple application (102) use per associated developer, social networking activity of users, data associated with particular consumers of applications (102) and so on. Because all applications (102) and associated consumer data stores are linked to the platform (100), the analytics engine (122) is operable to provide data analytics that is not available through other application platforms. In one aspect of the invention the analytics engine (122) is made access for example to developers or enterprises to enable them to enhance user experience of consumers, to discover interest in particular types of applications, application features, user workflows, graphical user interfaces and so on. The operator of the platform (100) may use the access management utility (118) to establish the parameters for accessing the analytics engine (122), or particular functions thereof. For example, the operator of the platform (100) may provide access to query functionality of the analytics engine (122) or to particular reports generated by the analytics engine (122) on a subscription or pay per access basis. Analytics from the analytics engine (122) may be licensed to advertisers for example to design advertising campaigns targeting users of the platform (100) by leveraging analytics to target ads to particular applications accessed by groups of consumers associated with the platform (100) who have a profile that matches the advertiser's targeting criteria.

In another aspect of the invention, the server application (206) includes or is linked to an eCommerce platform (126). The eCommerce platform (126) may be operable to maintain an account for users who are authorized to receive revenue by operation of the platform (100). For example, developers may accumulate advertising revenue share and/or subscription revenue based on consumer accessing applications (102) that they have rights to, or partial rights to. It is noted that the publishing system (114) may require the creators/contributors be named and associated distribution rights be defined, in connection with the ownership and distribution legal terms associated with the platform (100). In addition, consumers may receive revenue to accounts established by operation of the eCommerce platform (126).

In another aspect of the invention, the server application (206) may also include a rewards engine (128) that may be configured to link accumulation of particular rewards (based on reward parameters embodied in the rewards engine (128)) to particular events logged by the event logger (124). The rewards engine (128) also defines the rules for redeeming rewards, which may include distribution of currency by operation of the ° Commerce platform (126).

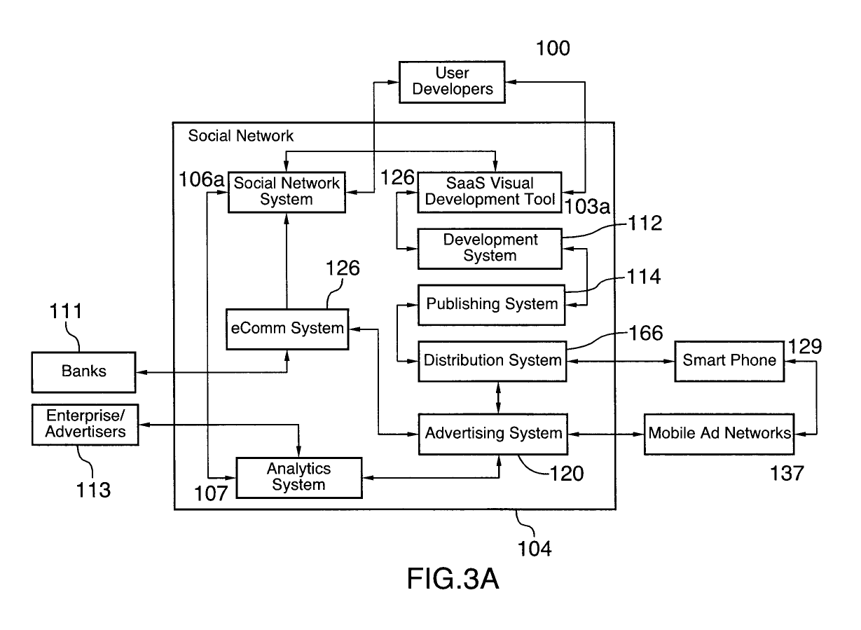

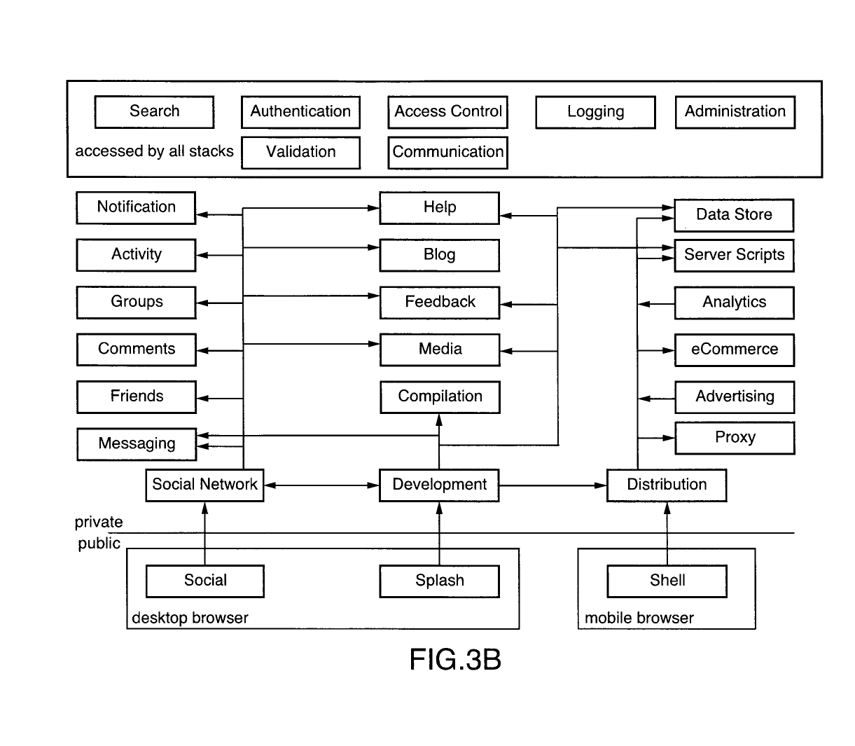

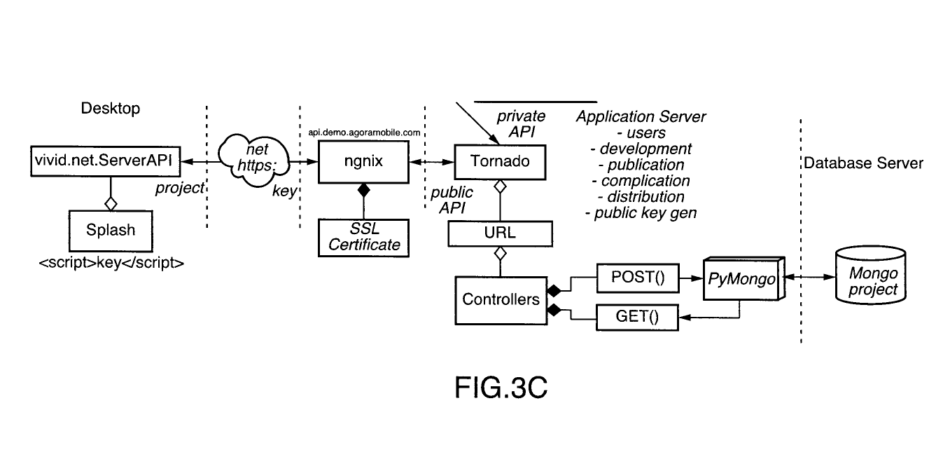

A further possible implementation of the social networking environment (104) of the present is shown in FIG. 3a. FIG. 3a illustrates a particular modular structure for implementing the social network of the present invention. A social network (104) is defined by the system, for use by users (100), whether they are consumers of applications or developers of applications, or both. The social network is enabled by a social network system (106a). A development system (112) may include a SaaS based visual application development tool or SaaS Visual Development Tool (103a). The development system (112) is linked to a publishing system (114) for publishing applications developed using the development system (112). The publishing system (114) is also linked to a distribution system (166) that includes a variety of tools for distributing applications within the social network (104). The distribution system (166), for example, enables the distribution of applications to smart phones (129). The smart phone (129) may be connected to a mobile ad network (137), The mobile ad network (137) may be linked to the advertising system (120) of the system, in order to enable the publication of ads through applications that are part of the social network (104). An analytics system (107) may be incorporated into the system of the present invention, and may be used in part to target ads using the advertising system (120). The analytics system (107) is operable to analyze social media interactions through the social network (104) or information from other data sources (such as interaction between users of the social network (104) and other social networks, social applications or non-social applications). The analytics system (107) may manage a profile for each user that may be used for targeting ads to users in order to generate revenue, for example for users who are developers. The system may incorporate an e-commerce system (126) for processing various transactions related to the activities through the social network (104), including for example consumption of applications. The e-commerce system (126) may be connected to banks (111). Also, analytics information made available using the analytics system (107) may be made accessible to enterprises or advertisers (113).

In a further aspect of the invention, the platform (100) may include one or more components that provide an auction utility, that allows users to sells applications, objects, scripts, templates, widgets, APIs, media, and other items to a purchaser that meets one or more selling criteria defined by the user. The selling criteria may include price but other parameters also.

Further Example of SaaS Architecture

Referring to FIG. 3b what follows is a further possible system implementation of the platform.

FIG. 3b shows an alternative SaaS architecture for implementing the resources of the present invention. A server stack model architecture may be used that allows implementation as a single system function. A Web 2.0 stack may be used to access the SaaS functions using for example either desktop computers or mobile devices. Network communication between the server stack and the client may be standardized using for example asynchronous REST APIs implementing JSON as a data exchange format.

A user authentication system may include SaaS features for supporting login and logout, user records, passwords, and security tokens. The user authentication system may include a validation sub-system that enables validation of tokens for all systems, and that may be accessed by all sub-systems for validation. The access control sub-system may include rules on objects allowing access to the object by a user or other object. Objects can be any entity in the system, including users, thereby permitting multilevel access and groups. The search sub-system permits location of any entity in all stacks, and may implement algorithms for discovery and categorization of search results.

The analytics sub-system collects user, system, application, financial, and network activities for analysis and display of patterns and trends within system.

The advertising sub-system may provide an internal interface for advertising in the social network and applications, optionally collecting ads from external ad aggregators while recording user impression and click activity for billing of ad generated revenues.

The e-Commerce sub-system provides services for buying and selling of applications, objects, scripts, templates, widgets, APIs, media, and so on, within system by users from other users inside social network and mobile apps linked to the social network provided. The e-Commerce sub-system provides users accounting information and analytics on their purchases and revenue. The sub-system may be linked to various external financial systems for purchasing and revenue delivery.

The development sub-system may provide user access to mobile development tools using for example Web 2.0 web applications, accessed through the social network environment described. The development sub-system may include one or more tools for managing development projects, which are then published using the distribution sub-system.

The compilation sub-system may enable compilation of visual programs written in the M data flow language. Compiled programs are returned to the development tool for development testing.

The distribution sub-system may provide user access to mobile applications shared in the system and built using development tools. This subsystem may distribute the apps to the mobile shell and provides access control through the ACL system, and may also enable in application purchases, accessing the eCommerce system and delivering ads provided by advertising system.

A JSON based data store may be used as a data storage system for all mobile apps on the social network. This may be accessed during development for schema and static data entry, and also implementing the ability to dynamically store and share information between and for apps.

The server scripts sub-system may implement functionality that provides users the ability to write scripts in the M data flow language that can be run on the server and access server side functions rather than on the mobile app.

The media sub-system may provide management, upload, storage and delivery of all static user media objects (images, URLs, video, text, sound) in the system used to build apps.

The friends sub-system may provide one or more features for managing and associating users with each other. Similarly, the groups sub-system may provide one or more features for managing and associating groups of users, apps, and comments.

The platform may include various engagement tools. For example, the comments sub-system may include a generic commenting system supporting attachment of comments on any object in the system. It may support comments in various media including text (with attachments) or video.

The server stack may also include a general notification system of activity objects provided as a time sorted stream of events. It may provide filtering of activities on object, user, group, and app basis. This may include for example server side filtering, fast front end pulls, and push to browser functionality. The general notification system may also include a mailbox for pushing events to users through the platform.

In one aspect of the invention, the platform incorporates a proxy service that circumvents the cross browser scripting problem of mobile web browsers, that allows web apps to log into secure APIs.

The system may include various messaging features for example providing user to user message passing in either email or chat style with media attachments.

A blog sub-system may support the creation and distribution of text or video articles that are searchable, catalogued on keywords, and enables user comments.

The communication sub-system may enable access to various external platforms or online environments (including for example 3^{rd} party social networks such as Facebook, LinkedIn, Twitter, Pinterest). The communication sub-system may enable collection of information from external networks and also publishing of information to external networks. In one aspect, the communication sub-system may integrate publishing activity on the platform with 3^{rd} party social networks. For example push notifications from the platform regarding platform activities may be published to the external platforms as publishing sources.

A video based help sub-system may provide user interface context awareness. It may enable search for relevant help content using for example key words. The help sub-system may include tutorial content for helping users build application development skills.

A generic feedback sub-system may enable users to provide comments on system activity. Feedback can be categorized and may automatically generate screen capture at the time of submission for support ticket analysis.

FIG. 3c illustrates a possible implementation of the system. In one implementation, PYTHON™ may be used as a primary programming language to implement the platform features described. An added advantage of using PYTHON is that other components may be written in C/C++ or GO and these may still be easily linked to the PYTHON based components. PYTHON also includes various libraries. FIG. 3c illustrates certain key libraries that may be used. In this case: TORNADO is used as the Application Server Framework, PyMongo (as the database connection), AsyncMongo (Database Asynchronous Layer), and cJson (High Performance Json Parser).

The server stacks may be standardized on the MongoDB NoSQL database system based on storing JSON objects. The use of a schemeless data storage system allows quick prototyping of complex data structures that would otherwise require complex SQL table structures. Mongo also supports high levels of small data communications which is characteristic the platform.

Stacks may communicate with each other through HTTP implementing the REST protocol defining the complete system API. All API requests by the stacks may be implemented with non-blocking asynchronous calls. The communication API may be divided into public and private versions. Clients may communicate with the system via public APIs while stacks communicate between each other using private APIs. All request data between the client and stacks is transferred using JSON.

In one implementation, the system has been designed to be scalable in order to support millions of users. Each component, library, platform, and technology may be selected and implemented to allow the system to scale using both horizontal (functional decomposition) and vertical (computational resource allocation) scaling principles. The system may be decomposed into a a network of computing nodes each performing a single function, and where nodes communicate through an asynchronous API. Adding more power to a function means adding more nodes performing that function. Adding more functions means adding more nodes doing these new functions. In this design each function can independently scale based on the systems requirements by dynamically adding more nodes. All these notes in this implementation are in the cloud.

Horizontal scaling is based on subdividing a large system into a set of smaller systems that each perform a single function in parallel. The system, in one implementation may be divided into a number of stacks that each perform a single logical function. Each stack is stand alone and handles all the requests for its own data.

The system may be designed to reduce dependencies between stacks where possible. The stacks may be designed in such a way that each URL or API is essentially stand alone. Any API/URL can be easily taken from one stack and put into another stack or into a whole new stack to host it, thereby allowing the system to scale out to micro services as needed.

The stacks are designed to be stateless such that any request, being asynchronous, does not depend on the state of the system or other systems to respond to a request correctly. By being stateless it is possible for a client to access the same API on two different platforms in succession with no problems. This solution provides scalability by not requiring requests to be hitting the same server.

By designing the systems to be stateless and running on independent nodes it is possible to cluster stacks individually as needed. At any time cloud services may be requested to bring new stacks online to scale existing functions with more machines. This increases scaling through vertical scaling by having a single function of the system supported by multiple stacks. These stacks may also be distributed geographically to support increased activity around the globe. When activity decreases these clusters can be removed.

The described implementation of the present invention provides a platform for web applications, that also includes data storage, API access, IDE, delivery, management, etc.

Social Networking Environment

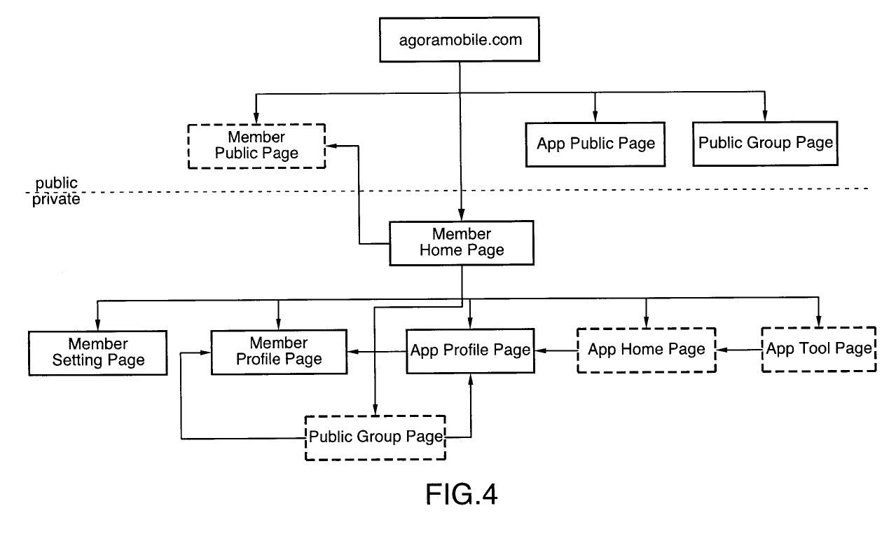

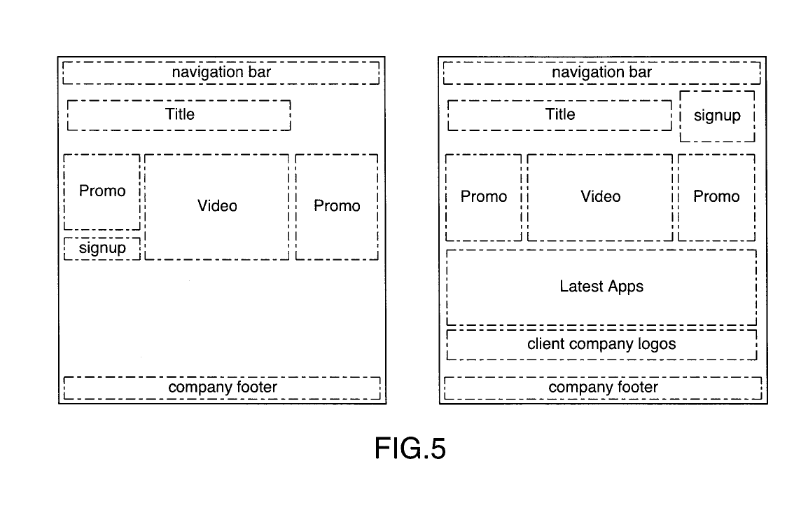

Certain possible attributes of the social networking environment (104) are described. The web presentment utility (232) is operable to generate a series of web pages, as directed by the social networking platform (106) so as to define a series of user interactions and/or workflows, including social interactions, that define the social networking environment (104) described herein. FIG. 4 illustrates the various different types of web pages that may be enabled by the platform (100), based on the functions of the web pages, as detailed below. FIGS. 5-8 include high level diagrams illustrating possible arrangements of the various web page types that are part of the social networking environment (104).

In one particular aspect of the invention, the social networking environment (104) enables users to define two types of web pages: public pages freely accessible via the social networking environment (104), and private pages only accessible to defined groups of users of the social networking environment (104). Users may determine rules for accessing private pages, for example by accessing a preferences utility (130).

FIG. 4 shows a representative web page structure for the social networking environment (104), in one particular implementation thereof. The arrows represent the explicit navigation paths necessary to reach a particular web page. Some web pages may be created dynamically by the web presentment utility (232), others may be generated based on request from a user. It should be understood that the present invention contemplates a fully functional social networking environment (104), including associated management utilities for managing user accounts, user data, applications, application data, groups, group data user, postings, user links, content moderation, and so on. These utilities enable the operator of the platform (100) to manage various functions of the social networking environment (104). Administrators may use these functions to engage in various initiatives for promotion of adoption of the platform (100) amongst users and also promoting engagements with users, including but not limited to promotions, contests, or social games.

A “home page” is generally private to its owner. The “member profile page” is a published version of a home page.

When a user accesses the social networking environment (104) for the first time, a login procedure is initiated, and the preferences utility (130) is initiated to collect information required to develop the profile for the member. Generally speaking the social networking environment (104) defines the following member profiles: (A) a developer profile, (B) a consumer profile (user of an application made by a developer, and optionally for an enterprise, (C) an enterprise profile for an enterprise, who may be publishing applications (102) through the platform (100), including applications developed by their personnel who are developers on the platform (100), or applications (102) developed by contacts with developers established via the social networking environment (104). It should be understood that developers may be consumers of other applications. Consumers of one application may be developers of another application.

Further referring to FIG. 4, the web pages served by the platform (100), as part of the social networking environment (104) generally include publicly accessible web pages and private pages. The public pages include “member public pages” (similar to a publicly accessible landing page for a user in a prior art social networking environment) and also “public group pages” (similar to publicly accessible landing pages for groups in prior art social networking environments). In addition, in accordance with another aspect of the invention, the social networking environment (104) also includes “application public pages” which may be publicly accessible landing pages, similar to those provided for a registered user in a prior art social networking environment for example, but in this case specifically directed to an application (100). Further details regarding application pages are provided below.

Application public pages are configured by authorized users by operation of the preferences utility (130) by configuring within the private web area of that user the application home page, as shown in FIG. 4. The application public page may contain various information regarding a particular application (100) including for example (A) summary of key features of the application (100), (B) ranking information for the application (100), as determined by operation of user metrics and feedback automatically collected by the analytics engine (122), and which may be filtered by the authorized user for selective display on the application publication pages, (C) if authorized by consumers, a list of platform users who have subscribed to this application, (D) external feeds regarding the application (100) such as external review and feedback posted to third party websites, (E) promotional material such as user guides (linked to the registered user's store on the database (108), contests or social games enabled by the gaming utility (132) of the platform (100), and (F) other possible tools or features to promote the adoption and use of applications (102). The application public pages may be shared through various social networks, resulting in the promotion of the application based on social media interactions that provides highly efficient and cost effective promotion of applications. Developers can develop their social networks so as to enable the promotion of their application to audience segments that map closely to the demographics of those to whom a particular application is most likely to appeal. The use of social networking in this new and innovative way provides significant advantages to developers (who can market application effective and develop “derivative” applications that based on requirements of very specific market segments) and to application users who in turn hear about and are able to use applications that are highly tailored to their demands or desires. It should be understood that the platform (100) may include the various tools, and may support the various operations, that may be based on best practices to build extensive social networks, manage social networks, and design and deploy social media based marketing campaigns.

In one aspect of the invention, the platform (100) may provide cloud instances of the system, which may be white labelled. These cloud instances may be used as enterprise branded cloud instances.

It should be understood that the server application (206) may include a series of tools, and embody best practices, for distributing and achieving traction in the adoption of applications (102). These tools and best practices may be regularly updated, and the authorized user (likely a developer or enterprise) may use the preferences utility (130) to assemble particular configurations of the system that best achieve the distribution objectives, and further accessing analytics from the system as described below, can monitor performance relative to these objectives and dynamically adjust strategies used. The web presentment utility (232) may of course be used to upload specific content such as text, graphics, artwork, video and so on to support promotion and distribution activities, which may be integrated for example in the application public pages.

The preferences utility (130) enables one or more settings pages in which the authorized user defines various parameters of the web pages described, that determine the social network interactions and/or experiences. For example, relevant settings may relate for example to the following settings related to distribution of applications (102): personal information, privacy and security, application publication, eCommerce information, appearance or arrangement of application or related materials, sharing and notification, and language.

In one aspect of the invention, the member home page is where a member arrives after logging into the social network environment (104). From this page each member is able to view their home page and enable a public version of this page. From this page they are able to access their settings by means of the preferences utility (130), and view and edit their page. The member home page also, for example for users with a developer profile, provides access to the various tools for developers, including in particular the development system (112). It should be appreciated, however, as previously mentioned that in the system of the present invention, each user may be a developer of an application (102) and also a consumer of applications (102). The present invention therefore does not differentiate between users who are developers and users who are consumers of applications.

The members may also define the rules for allowing others to access their pages by operation of the preferences utility (130). The member home page is also used to connect with other members by accessing one or more social features of the social networking platform (106) which connects to the member database (210) (as shown in FIG. 1 b), and is operable on the social interaction workflows for example to initiate the suggestion of social connections based on user preferences and/or user activities and other factors. Accepted connections may be stored to relationship database (220), which is operable to maintain for each member a social graph of their social connections, in a manner that is known.

Members from their main page may also create a variety of different groups, or visit groups. A landing page may be created for each group by the web presentment utility (232). The main page therefore is also operable to retrieve and display the various social connections and groups associated with a member, in a variety of views such as social graph clouds, lists of connections that may be parsed based on a number of different criteria. In a particular aspect of the present invention, social connections may from an application user perspective be based on or reflect a common interest in a particular type of application. From a developer perspective, the social connections may relate for example to a follower of a particular application, or a list of users who share an interest in an application having certain attributes. It should be understood that the present invention enables users with the appropriate permissions to mine information associated with such groups to discover insight regarding for example application related interests, and based on these insights develop new application or modify existing applications. The development of requirements for example for social game applications that are consistent with constantly changing trends, is improved in very significant ways by operation of the present invention,

Representative displays for the main profile page are illustrated in FIG. 5. The main profile page may also include applications suggested for the member, based on an iteratively accumulated interest profile obtained by operation of the analytics engine (122). The then current interest profile may be compared with the various applications (102) linked to the platform (100). As all applications (102) are linked to the platform, and application use and social interactions provide over time a fairly substantial underpinning for targeting of consumers with applications likely to be of interest to them, discovery of applications (102) is made easier, and in some aspects automated. This provides significant advantages to consumers by giving them applications that interest them, and saving them the time that is normally expended browsing application stores.

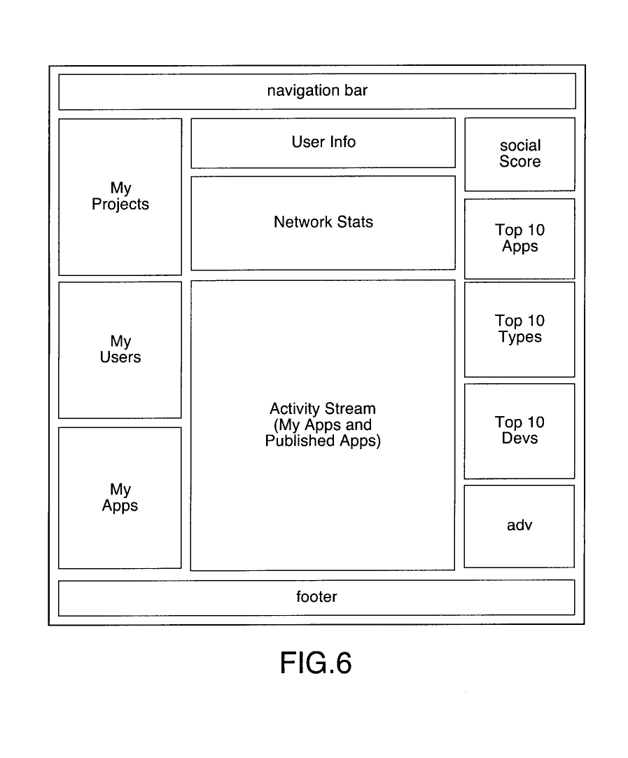

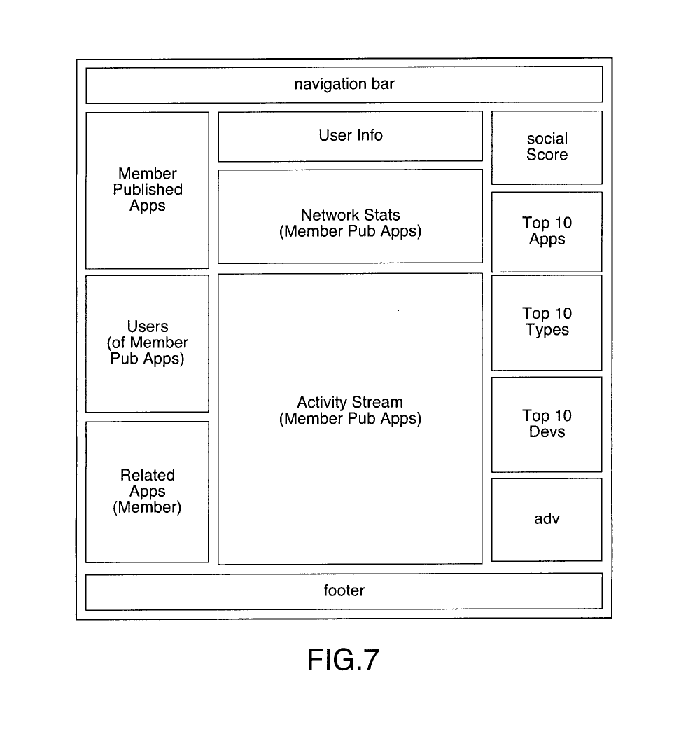

Another possible UI arrangement for a member profile page is illustrated in FIG. 6, in this case a consumer profile. Examples of some of the possible differences in a developer profile are shown in FIG. 7.

The member profile page may be published automatically by the social networking platform (106) for an authorized user. This is the web page that other members see. Only owners of this web page can modify the content of the page by visiting this page. This page can be accessed from the authorized user's home page or for example an application profile page that is usually controlled by one or more developers of the application (102), or the enterprise who owns the application (102).

In one aspect of the invention, members may use the preferences utility (132) to make the choice of publishing part of their profile page so that it is available to the general public outside of the social network environment (104). This page is accessed from the member home page and may provide two modes: not published and published. In either mode the member is able to edit the contents of the page elements provided by clicking on each one, using for example a built in editor gadget.

Generally speaking, however, it should be understood that all pages associated with the system of the present invention are only accessible by signing into the social networking environment (104).

The “application tool page” referred to for example in FIG. 4, provides to authorized users access to the functions of the development system (112). Again, the application tool page, and the development operations that it enables, permit developers to access various operations of the development platform in a user friendly way, and based on user interfaces and user workflows that are generally consistent with the overall user interfaces and Workflows used in the social networking environment (104) as a whole. In other words, the development related operations of the platform (100) are presented in a user friendly way, and in a way that seamlessly integrates with functions of the social networking environment (104). The social networking environment (104) may be based on workflows and user interfaces that are similar to those of social networking environments generally, and therefore will be familiar to most users who are users of other social networking environments. This familiarity promotes learning and ease of use and enables developers to learn to develop applications (102) using the platform (100) quickly, and also as further explained below, enables for example individuals with domain knowledge but who are not experienced developers, to develop and launch meaningful applications. These aspects of the invention support the rapid deployment and expansion of an active and dynamic developer community, and create more efficient market for application functionality.

The application tool page, in one implementation, is linked to one or more visual programming development tools (that are part of the development system (112)) that allow members to create, edit, and publish an application. The application tool page of the present invention innovates over the prior art by providing a unique and innovative collection of web pages that enable desktop-like metaphor for organizing movable and resizable editors anywhere on the page. This is done in order to lower the hidden dependencies between various editors and the components within them, namely the user interface, data sources, and scripts for the application. From this application tool page a developer can create applications for example from copies of existing applications. Copy semantics is implemented in the development system (112) in a pervasive manner so as to lower the abstraction gradient of the development tools.

When an application (102) is first created using the development system (112), the publishing system (114) automatically creates a home page for the application. This home page is also published to the associated consumers' home page in their list of applications, but remains hidden from other members until the owner (a term used to refer to the rights holder for the application, whether one or more developers, or one or more enterprises) explicitly publishes the application to the social network environment (104). The application home page is where the owner can modify information about the application and view analytical and financial information about the application's performance. From this page the owner is also able to publish the application which automatically creates an application profile page. The owner has the choice of publishing the application to friends, groups, or to the general public. When publishing to the general public the social networking environment (104) automatically creates a Public Application Profile Page for the application.

As stated earlier, an application profile page is an automatically generated page resulting from the publication of the application by its owner. This page is editable by the owner only and contains information about the application, for example it may contain the following: its owner, a link to the owner's profile page, a friends list, a comment listing, a status, a related application section, and a working version of the application with default values, a QR code (to enable easy distribution to a mobile device (110), a rating button, and a “share” function for enabling details regarding the application to be shared by users for example via third party social medial platforms such as FACEBOOK™, TWITTER™ or LinkedIn™.

As stated earlier, the public application profile page is an automatically generated page resulting from the general public publication of the application by its owner. This page also may contain information about the application, such as for example a link to the public profile of the owner, an un-editable comment list, a status, a related application section to other public applications, and a working version of the application with default values, a rating button, and a “share” function as described above.

“Groups” are a collection of members and applications. Group pages are designed to connect members and application based on one or more categorization criteria. Groups may be created automatically by operation of the analytics engine (122) linked to the member database (210), and storing output to the relationship database (220) that embodies the generated groups. Groups can also be created by members and published to their friends or the social networking environment (100 at large. A group can have more than one owner after it is created, and ownership can be transferred after the group page is created when the owner who created the page leaves the group. Friend groups can be private that is allowing group members to select number of members who can only be added by the owner of the group. Group pages may display members, the group name, its purpose, names of owners, associated applications, and associated social interactions that may be expressed as feeds for example comment feeds, discussions or other communications between members of the group, or automatically generated by the applications associated with the group page and captured as social media feeds generated and displayed in a manner that is known.

The social networking environment (104) may also support public group pages, which may be implemented as a limited public version of a group page that is available to the general public outside the social network environment (104). Such pages may be optional and informational only, and generally cannot be edited by the general public. Creation and modification of the page generally may only be done by the group owner. A public URL consisting of the web domain of the operator plus a group tag may be used to publish public group pages.

It should be understood that group pages enable users to dynamically configure web pages for enabling and capturing social media interactions regarding particular applications, types of applications, or other matters of common interest that may be related to particular application.

For example a group page may be created for “great golf applications” where users comment on different applications (102), discuss functionality which developers may use to extend for example features of an application. The group pages in effect automate user focus group activities and provide developers with a wealth of insight and knowledge that is ordinarily impossible to collect, or rather costly to collect, Access to this information promotes rapid development and distribution of applications, and updates to applications, that resonate with users thus creating a far more dynamic marketplace for applications.

Development System

The integration of application development tools described in the social networking environment (104) enables a novel and innovative application development workflow, and set of development utilities made part of the development system (112). Aspects of a possible development workflow are described below. The development system (112) may be understood as an application development utility, that is implemented as part of a computer networking implemented platform that implements or links to a social networking environment for development, publication and/or distribution of applications using the social networking environment.

It should be understood that the platform (100) supports a user friendly development workflow in a number of aspects. The platform (100) enables (A) a developer to manage and iteratively work on multiple application development projects through an easy to use set of user interfaces, (B) a rich set of possible functions and features are supported by the platform (100) and may be easily added or removed by operation of development system (112), (C) changes of application displays or features is easy, and therefore developers may use various strategies to test functionality, including for example dynamically assembled beta test groups, easily generated by the developer using the social networking platform (106), (D) analytics results may be used to dynamically adjust functionality over time, (E) derivative applications for example with different workflow or user interfaces but common features with other applications may be easily configured and deployed using the system (allowing different versions of applications targeted to different markets to be rapidly developed and deployed).

The development system (112) may be also used to create applications, objects, scripts, templates, widgets, APIs, media, and other items. For example, users may be able to use the development system to create widget sets using the platform's component framework.

Regarding the testing of applications (102) by users of the platform (100) who are developers, another aspect of the invention is that the platform (100) enables users who are developers to engage other users in the development of applications (100) in novel and innovative ways.

A prevalent prior art technique for soliciting input from potential users of an application is to replicate application functions, workflows, and/or user interfaces within one or more screenshots which may be placed in a series of web pages to simulate the operation of the application. The user experience of this type of simulation typically is not very good and may not be representative of the user experience desired from the eventual application. As such, this type of simulation may be of limited value in generating interest or input regarding for example an application by a user who is a potential consumer of an application, where a uses who is a developer is collecting interest information or input information from prospective consumers of an application, in considering development of a particular application. As can be appreciated, the social media functions of the platform (100) provide new and innovative mechanisms for users who are developers to discover application consumer demand insights, and to seamlessly translate these insights into development features within the same platform. In addition, the platform (100), based on a number of different features, enables a group of other users (such as a focus group of users with one or more shared interests relevant to the development or consumption of an application to “test drive” an application by accessing functioning test content and programming for a proposed application using a browser. It is significant that the user who is a developer may establish readily such focus groups, more efficiently than is possible using other solutions, by operation of the social networking environment (104).

An alternative to screenshot based simulations for mobile applications is to create a pre-commercial version of an application for download to a mobile device. Consumers are generally reluctant to download pre-commercial applications on a mobile device, and therefore while it is desirable to obtain user feedback regarding an application version that is more closely related to the intended commercial version than a screenshot based simulation for example, it may be difficult or costly to motivate a group of users to install a pre-commercial mobile application to their mobile device. In contrast, the present invention enables a focal group for example to experience through the platform (100) fully functioning applications through a web interface that provides a similar experience in terms of programming and content than would be available through the use of a launched version of the application from a mobile device through the platform (100). By operation of this aspect of the present invention, it is not necessary to download to a mobile device an application (102) in order to participate in a focal group for example, and interact with a functionality that is close to that of a commercial version of an application. This motivates users to participate in such a focal group, or other mechanisms for soliciting user feedback. This allows users who are developers to gauge interest before investing in developing applications. It allows users who are developers to develop applications that are of interest to users, and in particular to design programming and content in a way that responds to interests for example of niche groups. This aspect of the platform (100) provides surprising advantages in fostering development of applications that are more useful to users as a whole and responsive to group interests that otherwise may not be addressed by the current application marketplace.

In another aspect of the invention, the platform (100) enables the simplified installation of an application (102) such as a mobile application, leveraging the social networking environment (104). For example, from the perspective of a user, “LIKING” or equivalent of an application (102) through the social networking environment (104) initiates a one click installation of the application (102) through the social networking environment (104).

The application development platform according to the present invention may be understood, in one implementation as including: (A) accessing a new application home page created by the platform (100), (B) using the development system (112) to define one or more application attributes, (C) based on the attributes, the application home page displaying a selection of application feature objects (that consist of or link to executable code) that may be selected and based on selection be dynamically built in to a collection of feature objects that define (by operation of the server application (206) a functioning application (102), (D) selecting one or more visual components relevant to definition of a user interface for the application (102), including for example selected interface items (such as menus, screens and so on), objects from a media library, arrangements of links to feature objects in an application user interface, and (E) use of visual programming environment to arrange and configure the feature objects and associated visual components so as to enable the composition of a functional application (102).

The present invention may also be understood as including a computer network implemented method for developing and deploying applications including the following steps: (A) definition or collection of a plurality of data sources relevant to an application, (B) assembling an application interface that relates to (A) using an application interface design tool, and (C) using a visual programming language and environment to define one or more trigger-relations based on behavioural definitions determined by one or more developer users, the behavioural definitions relating to (A) and to (B), wherein the steps of (A), (B) and (C) enable the definition of a deployable application.

In one aspect, the development system may be used to capture existing APIs using the visual language implemented to the platform.

It should be understood that the platform (100) may link to and utilize various data sources, for example for the purpose of supporting development and deployment of applications (102). Data sources may be selected and adapted for use by an application (102) for example by selecting visually represented objects that may be mapped in the platform (100) to data, databases, web services, or cloud services, thereby linking data streams to an application (102).

The application may be deployed in a number of ways. In one aspect, deployment is achieved by means of “publication” of the invention which is user initiated. Once initiated, the platform (100) in one implementation is operable to initiate one or more operations related to deployment such as (A) creation of an application home page, (B) pushing notifications regarding applications to other social networks, (C) testing of application code, (D) copying of resources as required based on application features, (E) creation of database records for end users, and (F) notification of events to “friends” within the social network (such as publication of an application within a domain of mutual interest).

In a particular implementation of the invention, the platform (100) enables the creation of a virtual machine for each application that enables user-defined computations for the application. For other application operations, the platform (100) provides a wrapper for the application (100) and the development process in the background links the application to one or more applications features from one or more libraries linked to the platform (100),

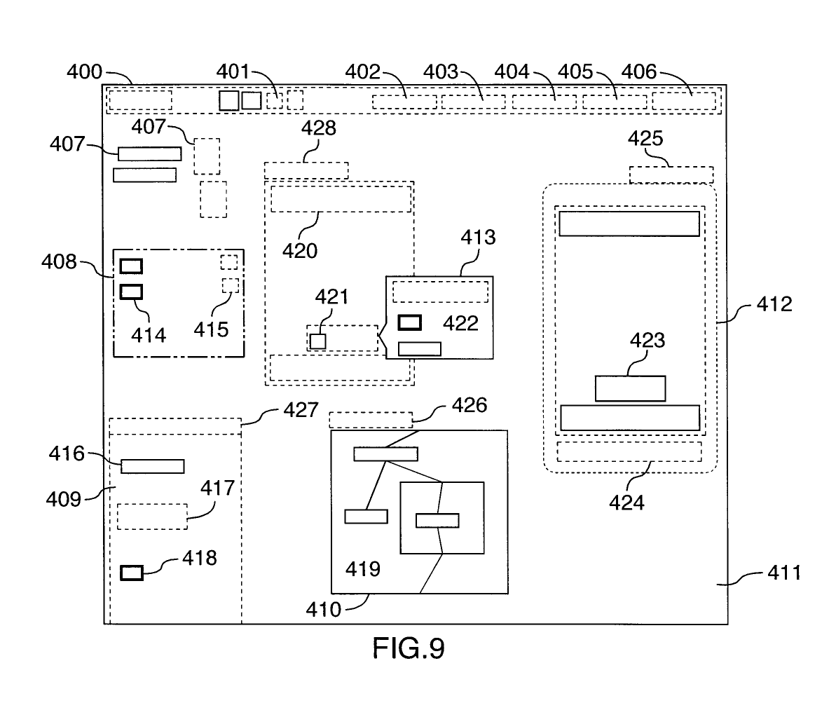

A representative interface enabling developers to access the mentioned application development functions is made part of FIG. 9.

In the interface (400 provides a browser window. (401) provides access to one or more editor controls, allow creation of new editors (data, view, script, simulator). (402) provides access to project controls. (403) provides access to one or more publishing controls. (404) provides access to search controls. (405) provides access to user identification functions. (406) provides access to one or more system controls. (407) provides access to a set of minimised, movable, icons for editors (e.g. data, view, and script editors), that when maximized transform into the selected editor. (408) provides access to a data editor, that enables the creation or selection of data sources. (409) consists of a media panel that may include a movable, resizable, scrollable panel of accordion controls sorted by type containing media. (410) provides access to a script editor that is used for defining application behaviour through visual programming. (411) indicates a workspace in which editors, panels, and floats exist. Each editor defines a function. Each project may be defined by a workplace which can be shared with other users through the system of the present invention, in order to enable collaborative development between users.

(412) provides access to one or more simulators for enabling an application of a project to be run.

(413) provides access to a property panel, which may consist of a floating panel that displays and allows editing of a view component's properties.

(414) indicates a data source item, which may be a dragable item representing a specific data type (boolean, string, number, etc.) that consists of a name value pair where value is the type. Data sources can be dragged to the view or script editor to create data links.

(415) is a data link indicator. Clicking the indicator reveals the item linked to, or can be used to create new links using dragging.

(416) includes a set of data flow operators that can be dragged to the script editor and copied to create new programs

(417) provides access to a set of view components that can be dragged to the view editor and copied to create new views.

(418) is a set of data sources that can be dragged to the data editor and copied to create new data sources.

(419) shows a controlled visual data flow program consisting of a data flow graph whose vertices are operators (416).

(420) is a view component in the view editor.

(421) is an event handler, accessed using an icon that indicates that a script has been attached to the view component (button) that will be executed based on some event type generated by a user/system interaction

(422) enables a user to view data and script properties, using a viewer component that can be modified by the user.

(423) is a running view component in the simulator that is active and responsive to user interaction.

(424) consists of phone buttons simulating the actual hardware buttons of the phone type.

(425) simulator controls: allow the control of the running of an app with stop, start, pause, resume functions as well as changing the platform skin (Phone vs. Android, and so on)

(426) script editor controls: allows the show/hide and movement of the editor as well as debugging controls.

(428) provides access to view editor controls that allow allows views to be shown/hidden, movement of objects, and changing of skins.

The application development platform enables developers to run development projects, save code, interact with development tools, enable the performance of multi-user edits (thus enabling collaborative development based on collaborative permissions configured using the preferences utility (132), enforcement of version control, digital media object asset management, management of development libraries and components.

As explained above, the development system (112) incorporates testing functionality to verify whether an application (102) is ready for distribution.

Also, as explained above, once an application (102) has been built and tested, it may be automatically published by operation of the publishing system (112). There is no waiting time for testing approvals by operators of third party platforms which can be a time consuming and costly process. Because applications are composed entirely using visual and functional components that are part of the platform, and components that may be linked with one another in the development system (112) are validated by the system operator as interoperating with one another, presentment of bugs and other errors is minimized. This reduces the time to market and also the costs involved in application development.

In one particular application of the present invention, the application (102) built by operation of the platform (100) are published with a hosted data flow virtual machine that performs all computations for the application (102).

Once an application (102) has been built and tested it may be authorized for distribution, by a simple web interaction with an authorized user. This triggers one or more distribution processes enabled by the publication system (114). For example the analytics engine (122) may automatically generate semantically relevant information for generating keywords for enabling advertising, and for populating recommendation areas of web pages described above, embedding of advertisement gadgets, linking to associated web pages within the social networking environment (104), and also optionally to external social networks.

In an additional aspect of the invention, applications (100) may be distributed to mobile devices (110) for example by making accessible to the mobile device a wrapper or “shell” which is essentially a “thin” mobile application that presents a mobile interface or portal on a mobile device (110) that may, in one implementation, present a login interface for a user to access the functions of the platform (100) including one or more applications (102) as further detailed in this disclosure. This “shell” may be automatically delivered to a mobile device (110) by a user scanning a QR code made available by the social networking environment (104) such as the application public page described above. The “shell” may also include programming that enables the capture, and communication to the event logger (124) of information regarding use of the application (102) from the mobile device (110).

In one aspect of the invention, the programming of the “shell” that is part of the standard functionality for each application (102) also includes functionality that enables the consumption of applications (102) by users in novel and innovative ways, and also enables the distribution of applications (102) in novel and innovative ways. In one aspect of the platform (100), a user togs into the platform (100) and is presented with a portal or dashboard that is personalized by the platform (100) for the user and that embodies one or more mechanisms for the user to navigate through applications (102) of interest to the user. The applications (102) of interest may include applications (102) that the user has selected in the past. One contribution of the present invention, is that because the platform (100) includes or links to a social networking environment (104), a user interacts not only with other users but in effect with applications, through his/her social media interactions in the social networking environment (104). For example, a first user may promote a new application (102) to one or more other users, via social media interactions. For example, the first user may “LIKE” the application (102). A second user who is a “friend” of the first user in the social networking environment (104) may receive a feed regarding the application (102) based on the first user “LIKING” the application (102). The second user may access through the feed information regarding the application (102), and indeed as discussed in this disclosure may experience the application (102) without the need to subscribe to the application (102) or download the application (102) to his/her mobile device. The second user (102) may “LIKE” the application (102) and may also promote the application (102) to a particular group of his/her “friends” whom the second user believes may find the application (102) interesting. In a particular aspect of the invention, with the user's permission, a broadcast of the “LIKE” of a user of a particular application (102) may be broadcasted to the various friends of the user. Much as other content such as videos or blog entries may be distributed very quickly through social networks to those whom are likely to be interested in the content based on viral distribution through the combined social graph of a large number of participating users, the platform (100) of the present invention enables the efficient promotion and distribution of applications (102).

Regarding “LIKING” or equivalent social media interactions, based on the described social networking environment (104), it is important to understand that the present invention produces a different “LIKE” relationship and result, than in the prior art. For example in FACEBOOK™, a 1:1 relationship is created between a user and content. The user may be part of the group, but there is still a 1:1 relationship relative to content, although you can see who the other users are that have also “LIKED” the same content. But there is generally no added benefit from seeing the other users who have “LIKED” the content. For example, the user is not able to contact other users who have “LIKED” the same content, nor is the user notified of activity in relation to the content. It is important to understand that the “LIKING” of an application (102) in connection with the present system is similar to joining a group in prior social media environments. In other words, by “LIKING” an application (102) the social networking environment (104) creates a relationship between the user and the other users who have also “LIKED” the same application (1020). Therefore, this social media interaction in relation to a particular application (102) produces a 1:n relationship that may be used to provide the benefit of obtaining updates regarding the application (102) and also potentially all other applications that the group of users linked to the application (102) area are also providing. This new and innovative mechanism for defining a relationship between a first user in a social media environment and content, such as an application (102), is an important insight in improving discoverability of applications. For example, various notifications may be generated by the system regarding new applications that a group defined by the users of a first application (102) may have “LIKED”. This provides in essence a crowd sourced application discovery service that did not exist prior to the present invention. In other words, each member of a group defined by shared interest in a particular application (102) benefits automatically from the collective application discovery efforts of the group.

In addition, the platform (100) including or being linked to the social networking environment (104) improves the accessibility of applications (102) or the navigation by users through applications (102) by tying social media interactions of the user involving one or more applications (102), or for example social media interactions by the friends of the user involving one or more applications (102), to the user accessing applications (102), for example by navigating the applications (102) through the user's portal mentioned above. For example, based on the mentioned social media interactions, the portal may automatically update the presentation of a series of icons linked to a plurality of applications (102) that the user has indicated interest in, or is likely to be interested in, based on the user's or his/her friends' social media interactions with the applications (102) as captured by operation of the social networking environment (104). It should be understood that this portal may be made part of a landing page or wall maintained for each user within the social networking environment (104). This functionality provides a more insightful way to discover applications (102) and also to find applications (102) of interest to the user, without being encumbered by the limitations on discoverability or navigability of applications from a mobile device. Many users, based on prior art solution, download a large number of mobile applications. But users often lose interest in such mobile applications, and it may be difficult or time consuming to delete these applications. Also, mobile device operating systems generally do not provide an intuitive interface for users to manage a larger number of mobile applications. The platform (100) solves this problem by, in one implementation, providing on the mobile device a single icon that acts as a link to the platform (100) and after signing in to the platform (100), the user accesses web content through the platform (100) that enables the management of a larger number of mobile applications, and in a way that is intuitive and social. It should be noted that carriers often in an attempt to control consumer activities on a mobile device tend to set restrictions on the consumer being able to customize how s/he consumes content or accesses mobile applications, for example by setting conditions on the creation/management of mobile web links or management of mobile application navigation features based on user preferences. This aspect of the platform (100) transforms the way in which users consume applications, especially mobile applications or web applications accessed using a mobile device by providing significant improvements over currently available solutions for consuming and managing mobile applications or web applications accessed using a mobile device, especially for users who desire ready access to a relatively large number of such applications.

It is worth highlighting that the portal described, linked to the social networking environment (104), enables not just navigation of applications that the user is familiar with, but also provides new and innovative mechanisms for discovering new applications. These mechanisms are made more efficient by relying on the social aspects of the platform (100). Through the social media interactions of a user, as well as the consumption of various applications (102), the platform (100) provides unprecedented application discovery functionality. The portal, in one implementation, provides a unified interface through the platform (100) to navigate between applications (100) that the user may used in the past, and also a starting point to use social media interactions to discover applications (102).

Another advantage of this approach is that this approach permits improved management of application use by employees using their mobile devices. Currently, enterprises try to limit the use of applications from the mobile devices of their employees because current solutions do not readily enable selective management of application use by employee users based on trust established by the enterprise. As a result, enterprises seek to limit use of applications from enterprise provided mobile devices all together. Enterprises fear for example that, based on prior art solutions, enterprise data that may be created or made accessible using a mobile application for example, may be accessed by a pernicious third party application on the mobile device that the employee user may have downloaded. Opportunity to leverage mobile applications for enterprise objective therefore may be missed.

In contrast, based on the portal described, an enterprise user of the platform (100) may design a set of enterprise related applications (102) and may also select for example a set of other applications (102) that are trusted by the enterprise. These may be placed in an enterprise associated folder in the portals of the enterprise's employees on the platform (100). The folder may also be updated easily from time to time by an enterprise administrator. The folder may contain icons associated with applications (102) that are trusted by the enterprise at the time. This also enables the enterprise to use the platform (100) to manage information created or made accessible across the trusted applications (102) so that data security is improved, and also enterprise data can be aggregated across multiple applications (102) being used by employee users of the platform (102) that enabling new data processing and data analytics functions.

In another aspect of the preset invention a user of the platform (100) (such as an enterprise user) may request the development of an application (102) (such as an enterprise related application). In one possible implementation, the platform (100) include an eRFP features or set of features that allows the enterprise user for example to: (A) define the software requirements,

(B) publish the details regarding the software requirements, and optionally one or more proposal parameters, including to all users, (C) initiating an eRFP module that may allow one or more proponents to submit their proposal and that may implement one or more processes for assessing proposals, and one or more processes for ranking proposals/proponents and/or selecting one or more preferred proponents.

Social Network

Social networks built around a common purpose using various Internet enabled technologies are well known. It should be understood, however, that the conception of a social network built around the interest in applications, for example mobile applications, expressed in creating a community built around their creation, their use, discussions around their use, and the monetization of apps and 3^{rd} party app components creating an virtual economy, is a novel and innovative contribution to the expanding art of social networking.

Some of the key social relationships enabled by the social networking environment (104) include:
Developers to Developers: developers befriend each other to gain access to technical knowledge, solve problems, and share code, or participate in group development projects.
Developers to Applications: each application is a virtual business developers look to in order to gain business intelligence, support, feedback and analytics to better understand their work and revenue.
Consumers to Applications: each application creates a group around which consumers can become friends and participate in a dialogue and express their views, opinions, and feelings about an application and invite or inform other friends of the applications regarding impressions of the utility, convenience, performance and other attributes of the application.
Consumers to Consumers: friending increases reach and scope allowing the discovery of more applications that may be of use. Consumer activity, such as commenting or using an application is broadcasted dynamically to the social network, thus allowing other friends to discover applications that they may be searching for.
Developer to Consumer: developers automatically receive a list of friends of their applications to whom they can broadcast updates, or market new applications. Developers also receive the benefits of direct feedback from their users for sentiment, bugs, or feature requests. Developers also receive network generated feedback in terms of analytics of the application itself, number of downloads, impressions, and potentially ad revenues. Once a significant number of developers have joined the social networking platform (106), the operator of the system of the invention is in a position to provide developers with the opportunity to purchase ads for their applications that would appear on the pages of consumer members that would not otherwise discover the application.

It will be appreciated that any module or component exemplified herein that executes instructions may include or otherwise have access to computer readable media such as storage media, computer storage media, or data storage devices (removable and/or non-removable) such as, for example, magnetic disks, optical disks, tape, and other forms of computer readable media. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD), blue-ray disks, or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, tracking module 30, object tracking application 34, etc., or accessible or connectable thereto. Any application or module herein described may be implemented using computer readable/executable instructions that may be stored or otherwise held by such computer readable media.

A skilled reader will recognize that other various extensions to the features and functions described are possible, such as incorporating various semantic analysis functions to the analytics engine (122).

It will also be appreciated that the block configurations, screen shots, and flowcharts provided herein are for illustrative purposes only and various modifications thereof are applicable within the principles discussed herein.

Although the above principles have been described with reference to certain specific embodiments, various modifications thereof will be apparent to those skilled in the art without departing from the scope of the invention and the claims appended hereto. Other modifications are therefore possible.

Business Model

The operator of the present invention may generate revenue through mobile advertising and enterprise subscriptions. Mobile advertisements may be distributed over-the-air to applications authored by developers by operation of the system. For example, mobile ad revenue may be collected by the operator and redistributed (for example to developers) based on sharing arrangements established in the platform. Subscription revenue may be based on providing access to a version of the development system (112) that enables the creation and deployment of ad-free applications (102).

It should be understood that the advertising may be paid for by brands. For example, a sports clothing manufacturer may want to place ads within applications (102) that are directed to athletes and sports enthusiasts. The present invention also contemplates “internal” advertising in the sense that developers for example may pay for ads in order to promote their applications.

It should be understood that applications themselves can be advertisements, rather than integrating an advertisement into an application, for example using a banner ad.

Although it has already been stated that in one aspect of the invention the platform (100) does not differentiate between different types of users, in the sense that a consumer of an application (102) can be a developer for one or more different applications (102), the platform (100) may also include in the wall for a user who is a developer of at least one application (102) a series of tools that together provide: (i) a storefront for one or more applications (102) linked to the user who is a developer, and also (ii) a dashboard for use by the user who is a developer, for example for managing sales and marketing activities related to the one or more applications (102), for other users who are consumers of the one or more applications (102). It should be understood that various functions and features may be integrated into such a storefront and such a dashboard. The platform (100) may also include or be linked to a transaction utility (234) which is operable to provide one or more payment platforms.

The transaction utility (234) is operable to enable the processing of payments that a user of the platform (100) who is a developer may associate to the use of an application (102), or aspects of the application (102). The storefront may be used for example, based on settings determined by the user who is a developer, to sell access to the application (102), or aspects of an application (102), based on a variety of possible monetization schemes.

In one aspect of the invention, the platform (100) may be associated with a multi-tier subscription revenue model. For example, use of the platform (100) by developers may be free, however, users who are developers may be required to pay to remove ads from their applications (102). In addition, certain advanced features of the platform (100) may be subject to additional fees, Additionally, certain value-added features of the platform (100) that may be useful in the development of applications (102) may also be subject to subscription fees (for example collaborative development features as described in this disclosure). The platform (100) may also be used to create feature rich, possibly customized areas used by enterprise clients for example application development companies or businesses who develop mobile applications for example as part of their business or promotion of their goods/services. However, the configuration of such areas may be subject to service fees, and the use of such areas may be subject to additional subscription fees. These areas may function as a “private social network” dedicated to an enterprise and its developers, who may log into such area using credentials specified by the enterprise client of the social networking environment (104). All information generated within the private social network is kept private within that network, and is not made available via the broader social networking environment (104), and is made accessible to users who are part of an enterprise defined group of users only.

Applications (102) may be shared/sold, parts of applications (102) may be shared/sold as part of a virtual goods marketplace enabled by the platform (100), for adaptation in to other applications (102). For example, application code may be shared/sold (for example functions, templates, libraries, binary files and so on) the application (102) may be a tool that can be shared/sold with other users who are developers for adaptation into other applications (102), media may be shared or sold (such as icons, images, sounds etc.), UI widgets may be shared/sold (such as buttons, list views, game parts, ships etc), based on pricing and other parameters defined by the user entitled to distribute the content in question.

As previously described, the platform may include an e-Commerce system that enables the sale of applications (102) and various component thereof.

Accordingly, the social networking environment (104) supports the distribution and sale of such “virtual goods”, for example by presenting these to other users who are developers on their home/profile page in the social networking environment (104). In one aspect, the platform (100) may be operable to analyze the type of application (102) that a user who is a developer is developing and based on this suggest various virtual goods components that may be of interest to the user. Purchases may be made for example using credit card and paypal micro-payments.

It should be understood that the easy and flexible distribution of applications (102), or parts of applications (102), promotes the development of more applications (102) (in part by enabling collaborative development, and also by enabling the development of derivative applications (102) that may share functional components for example but embody different media or different user workflows or features).

The dashboard of the user who is a developer, may provide access to a range of features such as for example (i) accessing application usage metrics, (ii) accessing user feedback regarding the application, including analysis or summaries of such feedback, (iii) identifying and rectifying software errors, (iv) managing the development and management of updates (including bug fixes), upgrades, new features, new versions, and derivative applications (collectively “updates”), and (v) management of communications regarding feedback, errors, and updates. It should be understood that the platform (100) permits users who are developers to automatically publish for example updates to the various users who are consumers of the relevant application (102). Also, the social networking environment (104) may be used for various aspects of the communications described. For example, communications regarding new updates may be broadcast as social feeds to the various consumers of the application (102), for example those who have “LIKED” the application (102) by operation of the social networking environment (104).

In another aspect of the invention, the dashboard may enable a user who is a developer to create and manage one or more groups of other users for the purpose of managing collaborative development projects related to applications (102). The social networking environment (104) may be used by a first user who is a developer to find other users who have the skills/expertise and interest to act as members of such collaborative development groups, for example by leveraging the matching capabilities of the platform (100). In order to support these collaborative activities, the platform (100) may provide access to a range of tools such as a collaborative development workspace, communication systems for use by developer groups that enable for example chat, messaging, voice, video, and screen sharing.

Despite the fact that the present disclosures describes different tools and environments (such as for example the storefront and also the collaborative development workspace described), in one aspect of the invention these different aspects are all experienced by users as part of the same seamlessly integrated social networking environment (104).

Advantages

Various advantages of the present invention have already been mentioned above. Further advantages of the invention are described below.

The present invention is designed to provide a scalable web environment. This web environment may be designed to assemble significant resources for developers to develop application, and also to enable application consumers to discover and acquire the right to use applications, via the platform (100). The platform (100) includes tools and content that are highly attractive to developers, and much improved mechanisms for discovering and accessing applications of interest. Valuable offerings to both developers and consumers of applications enable a virtuous circle based on a dynamic environment that attracts and gathers into a growing community of developers and consumers. More consumers attracts more developers and vice versa.

The platform (100) connects seamlessly to third party social networking environments, enabling users (whether developers or consumers) to invite new members to the social networking environment (104) of the present invention.

The platform (100) of the present invention provides an Internet platform that with its many resources and tools, creates a highly desirable Internet destination for building and consuming applications, including mobile applications.

The platform (100) integrates video, blog, and feedback to provide an effective learning model for users wanting to learn how to develop applications.

A further advantage of the invention is that the central database, and the central data stores made part of the central database, provides to users an advantageous hosted data solution. The hosted data solution enables users to store the information to the cloud, where it is safe from data loss that may otherwise result in the event of device damage or loss,

The social networking environment (104), enables for example enterprises to find developers with talent and expertise that is a good match for the enterprise's requirements for development of a particular application (102). The analytics engine (122) enables analysis of an enterprise's requirements for a particular application (102) and comparison to attributes determined for applications (102), and based on the developers thereof, the system is operable to match the enterprise with one or more possible developers.

The platform (100) of the present invention enables rapid development and entry to market for applications (102).

To supply more applications at the current rate of production is not possible. This means the market either needs more developers, or a new technology which allows existing developers to increase production. The present invention provides both. First, it allows more people to become developers by removing most of the complexity of build applications, which in turn, allows existing developers to make applications faster.

The development system (112) is configured to enable programming using a single language to create applications (102) that the system is operable to publish automatically to multiple platforms. For example the platform (100) is configured to enable the distribution of the applications to all main major mobile device platforms.

By reducing complexity associated with application development, the present invention in effect expands the development population very significantly, thus providing a supply for the demand for enterprise applications.

Another advantage of the invention is that it brings the developer and the consumers of an application closer through the social network. This allows the consumers to report bugs, request new features and give valuable feedback to the developer. Conversely, the invention enables the developer to react to the feedbacks from the consumers and bring updates or fixes to the consumer more quickly and establish a reputation for customer care.

The platform (100) also supports creation of new apps from shared templates. This shortens the learning curve for new users as well as seeding ideas for new apps. Users can explore existing application templates and start modifying an existing template and converting it into their own application distributable in the social network.

Creating client-server applications require much more expertise vis-a-vis stand alone applications. Not only a client-server app developer needs to have extensive knowledge of programming, there is also a need for setting up a server for handling requests and storing data. This means the need for access to a server and expertise for configuring such servers. Another advantage of this invention is that since data stores are integrated part of the platform (100), developers do not need to set up, configure and maintain servers to support client-server applications. A developer only needs to focus on creating the data store using the utilities available in the platform and not worry about the details of how the server side data is to be hosted and managed.

In virtual world, avid consumers pay attention to the reputation of the producers of the digital content. This invention facilitates an avenue for the developers to establish reputation and grow their follower base.

Another advantage of this invention is that the presented platform does not discriminate between users and developers. This potentially eliminates the many hurdles that a potential developer faces in order to enter the developers' circle. The platform makes the development tools easily and readily available to all members which encourages more users become developers.

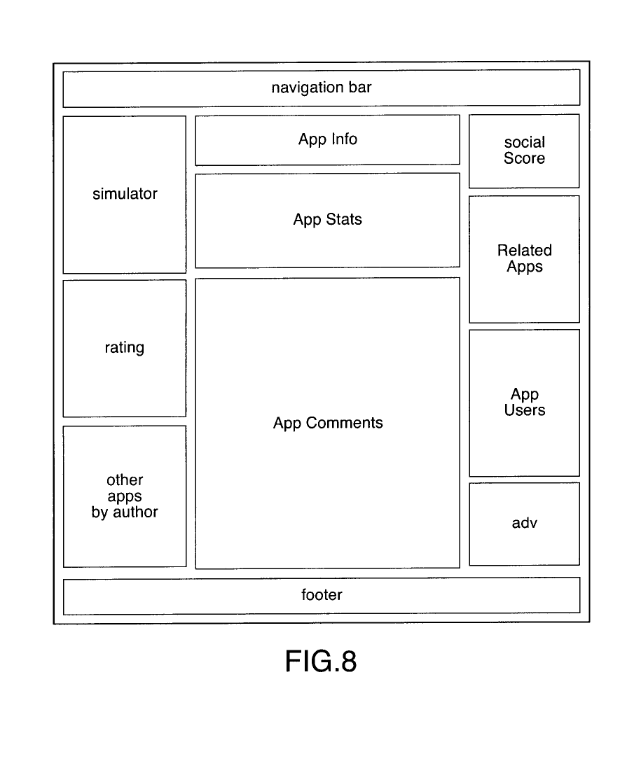

Often an application downloaded and installed by a user is not what the user expects it to be. Another advantage of the presented invention is that the distribution system (application page) as illustrated in FIG. 8 enables a customer to use the application in a simulated environment and make sure that it does what it is expected to do.

Different Possible Implementations

Depending on the particular implementation and various associated factors such as the resources of the mobile device, wireless network parameters, and requirements of the content distribution of social media platforms, different implementation architectures may be used for the present invention.

It should also be understood that the server (20) may be implemented as one or more servers in any possible server architecture or configuration including for example in a distributed server architecture, a server farm, or a cloud based computing environment.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present invention may be implemented as a web service, where the mobile device includes a link for accessing the web service, rather than a native application.

The functionality described may be implemented to any mobile platform, including the iOS platform, ANDROID™, WINDOWS™ or BLACKBERRY™.

It will be appreciated by those skilled in the art that other variations of the embodiments described herein may also be practiced without departing from the scope of the invention. Other modifications are therefore possible.

We claim:

1. A computer network connected computer system for developing computer programs comprising:
(a) one or more server computers connected to an interconnected network of computers;
(b) a computer network implemented social networking service implemented by the one or more server computers, or connected to the one or more server computers; and
(c) a computer network implemented application development service implemented by the one or more server computers;
wherein the social networking service and the application development service are integrated so that:
one or more users registered to the computer system can access one or more features of the application development service for designing and assembling one or more functioning applications, and publish these applications via the social networking service; and
one or more other users registered to the computer system can discover applications, select one or more applications, and access the applications through the computer system, using a network connected computer device or a mobile device.

2. The computer system of claim 1, wherein the application development service when accessed presents to the user one or more development screens configured to enable the one or more users to:
(a) select one or more application attributes for an application;
(b) select from one or more digital objects displayed by the application development service that correspond to application functional attributes, wherein the application feature objects consist of or link to executable code stored to a database linked to the computer system; and
(c) select one or more user interface items for the application from one or more further digital objects displayed by the development screens based on the selected application attributes and the application feature objects;
wherein the application development service dynamically builds the application based on the application attributes, application feature objects, and the one or more user interface items, so as to enable one or more application users to access the functions and features of the application by connecting to the computer system using their network connected computer device or mobile device.

3. The computer system of claim 2, wherein the application development service includes one or more computer program components including computer program instructions based on a visual programming language, such that the application development service enables the one or more users to select, arrange, and configure the application feature objects, which are executed by the computer system so as to present a functional application composed by the one or more users.

4. The computer system of claim 3, wherein the social networking service provides to registered users an application home page for one or more applications associated with one or more registered users, wherein the application home page presents public information defined by the registered users, and back end management features to the registered users for developing, maintaining, promoting, and distributing the application.

5. The computer system of claim 4, wherein the social networking service, or a social networking platform linked to the social networking service, enables users of the computer system to build and manage their social network, and the computer system enables the users who are registered to the computer system as controlling the application to:
(a) distribute applications using their social network;
(b) solicit feedback regarding applications, or development versions of applications, from their social network; and
(c) collaborate with members of their social network to develop and distribute applications.

6. The computer system of claim 1, wherein the application development service streamlines and simplifies the development of applications so as to enable subject matter experts to develop and distribute applications based on their subject matter expertise, and using their social network.

7. The computer system of claim 1, wherein registered users of the computer system may be developers of applications and users of applications by means of the computer system.

8. The computer system of claim 6, wherein the computer system includes or links to an e-commerce utility that enables users who are developers to monetize their applications, or components of applications such as objects, scripts, templates, widgets, APIs, media, and other items.

9. The computer system of claim 6, wherein the computer system automatically tracks applications linked to the system, and its components, and enables users controlling such applications or application components to set one or more rules for sharing such applications or application components with other users who may require access to application or application components, and based on such rules publishes applications or application components to one or more shared libraries, thereby reducing duplication across different application development projects that share common attributes.

10. The computer system of claim 1, wherein the computer system presents one or more screens that enable a group of users who are collaborating through the computer system in regards to developing or promoting an application, to agree to and implement an allocation of revenue generated by distributing the application as between the group of users.

11. The computer system of claim 1, wherein the computer system provides one or more tools that enable a developer user to use the social network to promote their application, including:
(a) an application store that allows user of the computer system to search for and access information regarding applications that map to their interests; and
(b) a targeting tool that permits developer users to target users who may be interested in an application including based on segmented targeting of users based on the computer system developing insights regarding the subject matter interests of users.

12. The computer system of claim 11, wherein computer system, information regarding applications that may be of interest to a user is distributed using social media feeds through the social media service or the social media networking platform linked to the computer system.

13. The computer system of claim 11, wherein the computer system uses logs and analyzes automatically social media feeds associated with users to discover interests of users in applications and generate data for promoting applications to groups of users.

14. The computer system of claim 13, wherein the computer system presents to developer users a dashboard that includes information and tools that assist the developer users in promoting their application, including via the social network or the social networking platform linked to the computer system.

15. The computer system of claim 1, wherein computer system includes an advertising sub-system that provides users with a user interface to configure parameters for publishing ads from ads from external ad aggregators to applications, that records user impressions and click activity, and that allocates ad generated revenue based on such impressions and click activity.

16. The computer system of claim 1, wherein the computer system includes or links a data store, which is configured to operate as a shared data store across a plurality of applications linked to the computer system.

17. The computer system of claim 15, wherein the computer system includes a data management utility that enables developers users to manage data collected using their application(s).

18. A computer implemented method of developing one or more applications using a computer network implemented development platform, comprising the steps of:
(a) a user accessing an application development utility that is implemented to one or more servers connected to an interconnected network of computers and linked to at least one server application, wherein the server application enables a social networking environment, or links to a social networking environment;
(b) the user employing the application development utility to select one or more application attributes for an application;
(c) the user selecting, from one or more digital objects displayed by the application development utility, application feature objects corresponding to the application attributes, wherein the application feature objects consist of or links to executable code stored to a database linked to the server application;
(d) the user selecting one or more user interface items for the application from one or more further digital objects displayed by the application development utility based on the application attributes and the application feature objects; and
(e) the application development utility dynamically building the application based on the application feature objects and the one or more user interface items so as to enable one or more application users to access the application using one or more network connected devices via the server application;
wherein the server application enables the user to develop, publish and distribute the application by means of the social networking environment.

19. The method of claim 1, wherein application users find the application and gain access to the application using the social networking environment.

20. The method of claim 1, comprising the further step of the user employing the application development utility to access a visual programming language and visual programming environment and to arrange and configure the application feature objects and the one or more associated user interface items so as to enable the composition of a functional application.

21. The method of claim 1, wherein the application developer utility presents an application home page for the application, that enables the development, publication and distribution of the application using the social networking environment.
